(19) United States
(12) Patent Application Publication
(10) Pub. No.: US 2026/0238339 A1
(43) Pub. Date: Aug. 13, 2026

(54) COMMUNICATION APPARATUS, FREQUENCY OFFSET ESTIMATION METHOD AND PROGRAM

(71) Applicant: NTT, Inc., Tokyo (JP)

(72) Inventors: Takahiro SUZUKI, Musashino-shi (JP); Sang-Yuep KIM, Musashino-shi (JP)

(73) Assignee: NTT, Inc., Tokyo (JP)

(21) Appl. No.: 19/158,002

(22) PCT Filed: Mar. 9, 2023
(86) PCT No.: PCT/JP2023/009074

§ 371 Date: Aug. 19, 2025

(51) Int. Cl. H04B 10/075; H04B 10/61

(52) U.S. Cl. CPC H04B 10/075; H04B 10/61

(57) ABSTRACT

A communication device includes a control unit that performs a true value estimation process of estimating a true value of a frequency offset based on an electrical digital signal that is a digital signal obtained based on an optical signal that is an optical signal received in a digital coherent reception method and indicating a symbol string composed of a plurality of symbols and a local oscillation light and a digital signal transmitting the symbol string with an electrical signal, in which, in the true value estimation process, the control unit performs a preceding estimation process of estimating a tentative estimated value that is a value of the frequency offset for each of the symbols included in the electrical digital signal, and a subsequent estimation process of estimating the true value based on a set of the tentative estimated values estimated in the preceding estimation process.

### TECHNICAL FIELD

The present invention relates to a communication apparatus, a frequency offset estimation method, and a program.

### BACKGROUND ART

In a digital coherent reception method, a shift occurs in optical frequencies of the transmission-device-side light source and the receiver-side light source, and the constellation of reception signals rotates. Therefore, a frequency offset is estimated to compensate for the rotation. As a technique of such frequency offset estimation, Pre-decision-based Angle Differential Estimator (PADE) is known (see Non Patent Literature 1).

FIG. 9 is an illustrative diagram for describing a PADE. In the PADE, the phase of a signal r(k) is calculated, and tentative determination resulting from subtraction between the initial value C and the cumulative value of the frequency offset estimated in one-previous cycle, and estimation of the symbol position after frequency offset compensation are performed.

Thereafter, in the PADE, a new accumulated value of the frequency offset is then estimated from subtraction from the phase value of the input signal. By subtracting the value from the accumulated value of the frequency offset of the immediately previous symbol, a new estimated value of the frequency offset is calculated.

In the PADE, in a case that the absolute value of the estimated value of the frequency offset is larger than II, the estimated value is removed as noise. In addition, in the PADE, a loop filter stabilizes the solution. The frequency offset Δφₖ is obtained by performing such processing once or looping the processing a plurality of times.

FIG. 9 also illustrates an implementation example of a loop filter. The loop filter uses a parameter α. FIG. 10 illustrates a simulation result of the frequency offset estimation by a PADE when the initial value of the estimated value of the frequency offset is 0 and α=0.01 for the input signal having the baud rate of 1.25 GBaud/s and the frequency offset of −0.7037 (rad). FIG. 11 is a result for the same input signal as the input signal in FIG. 10, and shows a simulation result of estimation by a PADE when α=1. Note that, in FIG. 11, the results of performing simulation on different samples a plurality of times are drawn in an overlapping manner.

### CITATION LIST

### Non Patent Literature

Non Patent Literature 1: L. Li et al., “Wide-range, Accurate and Simple Digital Frequency Offset Compensator for Optical Coherent Receivers,” in Proc. OFC/NFOEC 2008, OWT4, 2008.

### SUMMARY OF INVENTION

### Technical Problem

However, in the conventional technique using a PADE, when α is small, the value converges to the target value and noise of the estimated value is small, but since a number of repetitions are required until the value converges, much processing time is required. On the other hand, when α is large, an estimated value appears near the solution with a small number of repetitions, but an accurate solution cannot be obtained. This is because, for example, in a case that the solution is described as S and the baud rate is described as Br, an estimated value of a state in which noise is added to S+2π/m (i is an integer, and when an m-PSK signal is received) is obtained between [−π, π]. As a result, α is limited to a small value, and it takes time to estimate the frequency offset.

In view of the above circumstances, an object of the present invention is to provide a technology for speeding up estimation of a frequency offset.

### Solution to Problem

An aspect of the present invention is a communication device including a control unit that performs a true value estimation process of estimating a true value of a frequency offset based on an electrical digital signal that is a digital signal obtained based on an optical signal that is an optical signal received in a digital coherent reception method and indicating a symbol string composed of a plurality of symbols and a local oscillation light and a digital signal transmitting the symbol string with an electrical signal, in which, in the true value estimation process, the control unit performs a preceding estimation process of estimating a tentative estimated value that is a value of the frequency offset for each of the symbols included in the electrical digital signal, and a subsequent estimation process of estimating the true value based on a set of the tentative estimated values estimated in the preceding estimation process.

An aspect of the present invention is a frequency offset estimation method including a control step of performing a true value estimation process of estimating a true value of a frequency offset based on an electrical digital signal that is a digital signal obtained based on an optical signal that is an optical signal received in a digital coherent reception method and indicating a symbol string composed of a plurality of symbols and a local oscillation light and a digital signal transmitting the symbol string with an electrical signal, in which, in the control step of the true value estimation process, a preceding estimation process of estimating a tentative estimated value that is a value of the frequency offset for each of the symbols included in the electrical digital signal, and a subsequent estimation process of estimating the true value based on a set of the tentative estimated values estimated in the preceding estimation process are executed.

An aspect of the present invention is a program that causes a computer to function as the above-described communication device.

### Advantageous Effects of Invention

According to the present invention, it is possible to speed up estimation of a frequency offset.

### BRIEF DESCRIPTION OF DRAWINGS

FIG. 1 is a diagram illustrating an example of a communication system according to an embodiment.

FIG. 2 is a diagram for describing an example of processing executed by a control unit included in a reception device according to the embodiment.

FIG. 3 is an illustrative diagram for describing a first example of a true value estimation process according to the embodiment.

FIG. 4 is a diagram illustrating an example of a hardware configuration of a training device according to an embodiment.

FIG. 5 is a flowchart illustrating an example of a flow of processing executed by the training device according to the embodiment.

FIG. 6 is an illustrating diagram for describing a second example of the true value estimation process according to the embodiment.

FIG. 7 is a diagram illustrating an example of a hardware configuration of a reception device according to the embodiment.

FIG. 8 is a flowchart illustrating an example of a flow of processing executed by the reception device according to the embodiment.

FIG. 9 is a first illustrative diagram for describing the related art.

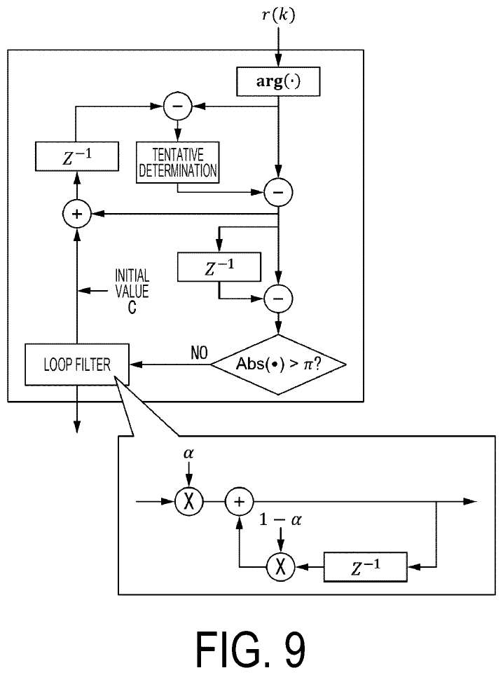

FIG. 10 is a second illustrative diagram for describing the related art.

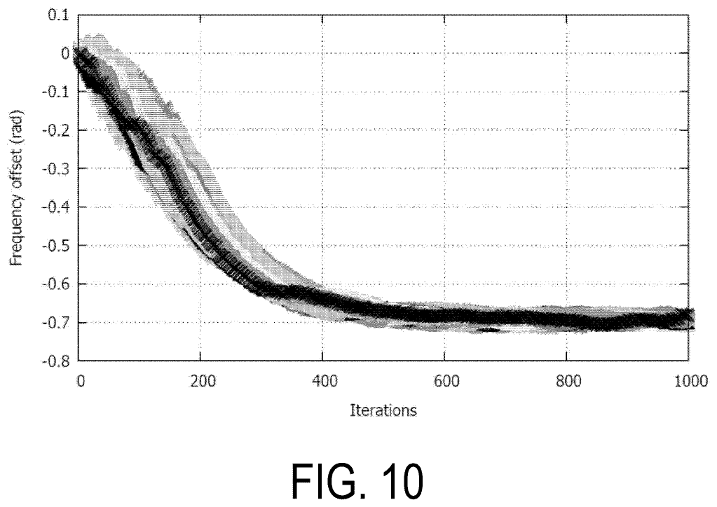

FIG. 11 is a third illustrative diagram for describing the related art.

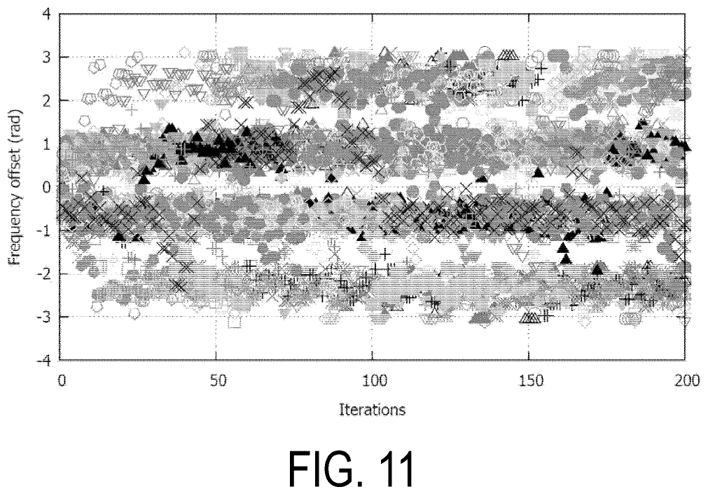

### DESCRIPTION OF EMBODIMENTS

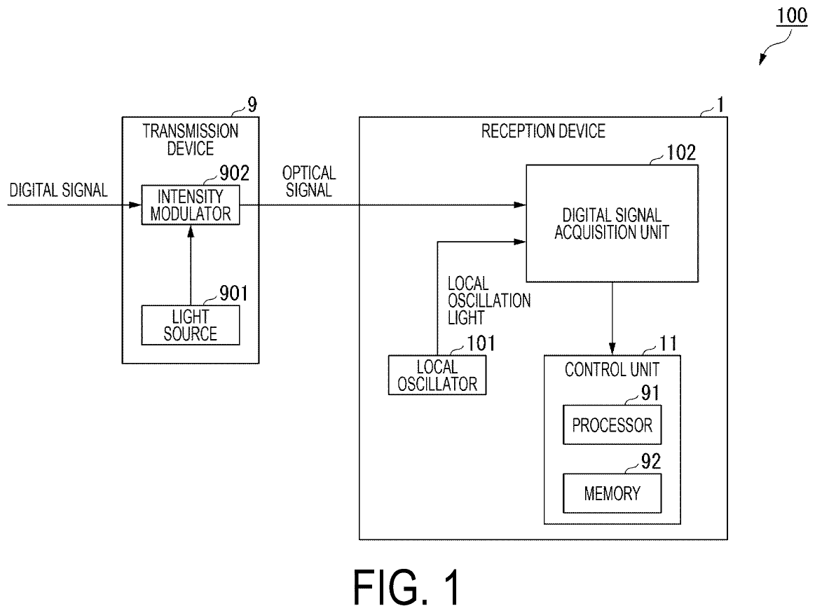

FIG. 1 is a diagram illustrating an example of a communication system 100 according to an embodiment. The communication system 100 transmits and receives information by digital coherent communication. The communication system 100 includes a transmission device 9 and a reception device 1.

The transmission device 9 transmits an optical signal indicating a symbol string including a plurality of symbols to the reception device 1. The transmission device 9 includes a light source 901 and an intensity modulator 902. The light source 901 outputs light of a predetermined frequency to the intensity modulator 902. The intensity modulator 902 receives input of digital signals. The intensity modulator 902 modulates the intensity of the light output from the light source 901 according to the received digital signal, and outputs the modulated light. The signal output by the intensity modulator 902 in this manner is an optical signal transmitted by the transmission device 9.

The reception device 1 receives the optical signal transmitted by the transmission device 9 (hereinafter, referred to as a “transmission optical signal”) by using a digital coherent reception method. The reception device 1 includes a local oscillator 101, a digital signal acquisition unit 102, and a control unit 11 that includes a processor 91 such as a central processing unit (CPU) connected via a bus and a memory 92 and executes various types of signal processing such as sampling phase synchronization.

The local oscillator 101 outputs local oscillation light. The digital signal acquisition unit 102 obtains an electrical digital signal using the local oscillation light and a transmission optical signal. The electrical digital signal is a digital signal that transmits a symbol string indicated by the transmission optical signal with an electrical signal.

Therefore, the electrical digital signal is a digital signal obtained based on an optical signal received in the digital coherent reception method indicating a symbol string composed of a plurality of symbols and the local oscillation light. Furthermore, the electrical digital signal is a digital signal that transmits the symbol string with an electrical signal.

Since the transmission optical signal is an analog signal, the digital signal acquisition unit 102 executes analog-digital conversion for converting the analog signal into a digital signal. A technique of acquiring an electrical digital signal by the digital signal acquisition unit 102 may be a well-known technique, and is, for example, coherent detection. Therefore, the digital signal acquisition unit 102 includes, for example, a light receiving element and an analog-digital converter.

In this manner, the optical signal transmitted by the transmission device 9 is converted into an electrical digital signal that is a digital electrical signal in the reception device 1.

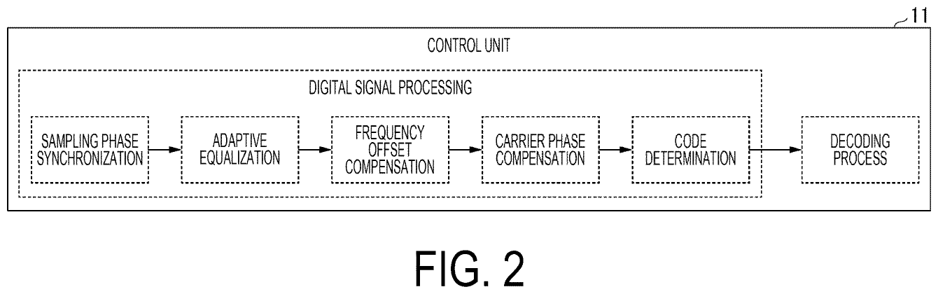

The control unit 11 acquires the electrical digital signal. FIG. 2 is a diagram for describing an example of processing executed by the control unit 11 included in the reception device 1 according to the embodiment. The control unit 11 executes digital signal processing and a decoding process that is processing for performing decoding. The decoding process is, for example, a process of performing decoding including error correction. In the digital signal processing, as illustrated in FIG. 2, at least each processing of sampling phase synchronization, adaptive equalization, frequency offset compensation, carrier phase compensation, and code determination is sequentially executed.

The sampling phase synchronization is processing of controlling sampling in analog-digital conversion by the digital signal acquisition unit 102. The adaptive equalization by the control unit 11 is, for example, adaptive equalization for an electrical digital signal, and is adaptive equalization using a finite impulse response (FIR) filter (finite impulse response filter).

The frequency offset compensation includes processing of estimating a true value of a frequency offset (hereinafter, referred to as “true value estimation process”). Note that a frequency offset is a difference between the frequency of local oscillation light and the frequency of light output from the light source 901 included in the transmission device 9.

Specifically, the frequency offset compensation by the control unit 11 is processing of reducing a deviation of constellation indicated by an electrical digital signal caused by the frequency offset based on the true value of the frequency offset estimated by true value estimation process. The method of compensation may be compensation by changing the oscillation frequency of the local oscillator, or may be compensation by the control unit 11 reversely rotating the constellation at a phase rotation speed corresponding to the true value of the frequency offset. The true value estimation process will be described below in detail.

Specifically, carrier phase compensation by the control unit 11 is processing of compensating for the phase offset with respect to the electrical digital signal after the frequency offset compensation. Specifically, sign determination by the control unit 11 is processing of performing symbol determination on the electrical digital signal after compensation for the phase offset.

### True Value Estimation Process

The true value estimation process includes preceding estimation process and subsequent estimation process. That is, in the true value estimation process, the preceding estimation process and the subsequent estimation process are executed. The preceding estimation process is processing of estimating a value of a frequency offset for each of a plurality of symbols included in the electrical digital signal.

Such preceding estimation process is processing using a Pre-decision-based Angle Differential Estimator (PADE) as described below, for example. However, the preceding estimation process is not necessarily processing using a PADE. The preceding estimation process may be, for example, processing of executing a trained preceding mathematical model. The trained preceding mathematical model is a trained mathematical model that estimates a frequency offset based on a symbol, and is a trained mathematical model obtained from training using a set of a symbol and a value of a frequency offset as training data.

The subsequent estimation process is processing of estimating a true value of the frequency offset based on a set of values of the frequency offset estimated in the preceding estimation process.

Such true value estimation process may be any processing as long as the true value of the frequency offset can be estimated from the preceding estimation process and the subsequent estimation process. Therefore, here, two examples of the true value estimation process will be described.

### First Example of True Value Estimation Process

A first example of the true value estimation process will be described. A first example of the true value estimation process is a process of executing a PADE on each of a plurality of symbols included in an electrical digital signal and estimating a true value of a frequency offset using a trained mathematical model obtained in advance by machine learning based on the result of the execution. Here, the process of executing the PADE on each of the plurality of symbols included in the electrical digital signal and estimating a frequency offset for each symbol is an example of the preceding estimation process.

Hereinafter, an estimated value of each frequency offset obtained by the PADE for each symbol is referred to as a tentative estimated value. Hereinafter, the process of executing the PADE on each of the plurality of symbols included in the electrical digital signal and estimating a frequency offset (that is, a tentative estimated value) for each symbol is referred to as tentative estimated value estimation process. The process of estimating the true value of the frequency offset using a trained mathematical model obtained in advance by machine learning using a set of tentative estimated values obtained in the tentative estimated value estimation process is an example of the subsequent estimation process.

The difference from the estimation of the true value of the frequency offset by a PADE of the related art will be described. In a case of a PADE of the related art, time-series symbols indicated by an electrical digital signal are sequentially input to the PADE one per cycle in a time series manner. Thus, when cycles are different, the input symbols are not necessarily the same. On the other hand, with respect to a PADE in the true value estimation process, the PADE is executed for each symbol. Executing the PADE for each symbol means that, for example, in the case of the PADE for a symbol r1, a symbol time series having the symbol r1 as the only symbol is generated, and the time series symbol is input to the PADE one per cycle. The symbol time series is a time series of symbols.

Thus, a tentative estimated value for the symbol r1 is obtained. For this reason, for example, when the electrical digital signal is a time series of three symbols r1, r2, and r3, first, a symbol time series in which all symbols are symbols r1, a symbol time series in which all symbols are symbols r2, and a symbol time series in which all symbols are symbols r3 are generated based on the electrical digital signal. Next, a PADE for the symbol time series in which all symbols are symbols r1, a PADE for the symbol time series which all symbols are symbols r2, and a PADE for the symbol time series in which all symbols are symbols r3 are executed. As a result, the tentative estimated value for the symbol r1, the tentative estimated value for the symbol r2, and the tentative estimated value for the symbol r3 are obtained.

Hereinafter, such a process of executing the PADEs on the symbol time series in which all symbols are the same is referred to as a thread. Therefore, in the above example, it can be said that a thread for the symbol r1, a thread for the symbol r2, and a thread for the symbol r3 are executed for the electrical digital signal that is the symbol time series of the three symbols r1, r2, and r3. The output of the thread for the symbol r1 is a tentative estimated value for the symbol r1, the output of the thread for the symbol r2 is a tentative estimated value for the symbol r2, and the output of the thread for the symbol r3 is a tentative estimated value for the symbol r3.

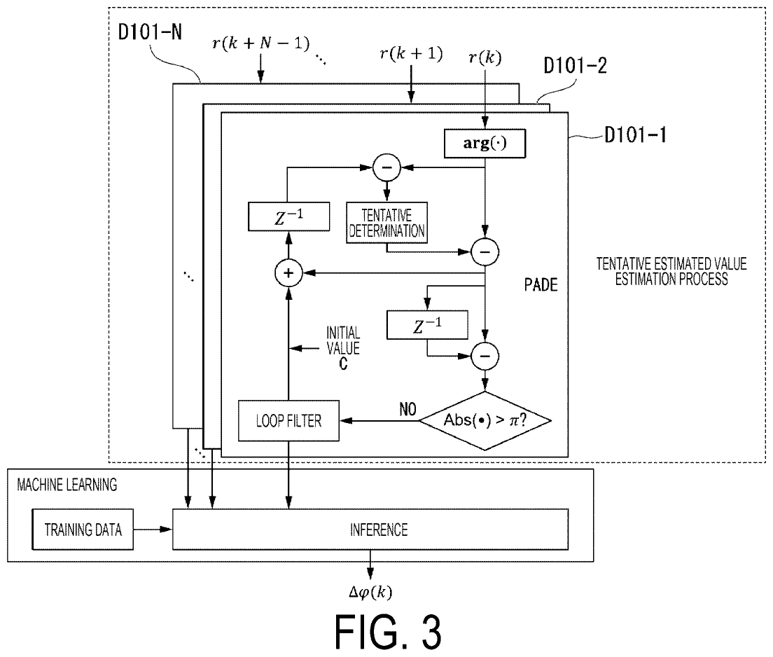

FIG. 3 is an illustrative diagram for describing the configuration. That is, FIG. 3 is an illustrative diagram for describing a first example of the true value estimation process according to the embodiment. FIG. 3 illustrates N threads from a thread D101-1 to a thread D101-N (N is a natural number). A thread means a PADE executed for each symbol indicated by an electrical digital signal. For example, in the case of the thread D101-1 of FIG. 3, a PADE for the time series of a symbol r(k) is executed, and a tentative estimated value for the symbol r(k) is output through a process such as a loop filter. For example, in the case of the thread D101-N of FIG. 3, a PADE for the time series of the symbol r(k+N−1) is executed, and a tentative estimated value for the symbol r(k+N−1) is output through a process such as a loop filter.

FIG. 3 illustrates that a mathematical model for performing inference is a trained mathematical model obtained in machine learning using training data. In the case of the example of FIG. 3, the trained mathematical model estimates a true value Δφ(k) of the frequency offset based on the tentative estimated value obtained in each of the threads from the thread D101-1 to the thread D101-N.

### About Training

Here, training for obtaining a trained mathematical model used in the first example of the true value estimation process will be described. A training target in the training for obtaining the trained mathematical model used in the first example of the true value estimation process is a mathematical model for estimating the true value of the frequency offset based on one or a set of a plurality of tentative estimated values. Hereinafter, a mathematical model for estimating the true value of the frequency offset based on one or a set of a plurality of tentative estimated values is referred to as a true value estimation model.

Training of the true value estimation model is, for example, supervised training. In such a case, the training data used for training the true value estimation model includes correct answer data. The training data used for training of the true value estimation model is a set of tentative estimated values and the true value of the frequency offset. The true value of the frequency offset is used as correct answer data in training. Thus, a set of tentative estimated values is input to the true value estimation model in training.

The training of the true value estimation model is a process of repeating a training time true value estimation process and a model update process until a training end condition is satisfied. The training time true value estimation process is a process in which the true value estimation model estimates the true value of the frequency offset based on a set of tentative estimated values included in the training data.

The model update process is a process of updating the true value estimation model so as to reduce a difference between the true value estimated by the execution of the training time true value estimation process and the true value indicated by the correct answer data included in the training data. The training end condition may be, any condition as long as it is a condition for ending training, and may be, for example, a condition that the training target has been updated a predetermined number of times, or may be a condition that the change of the training target caused by update is smaller than a predetermined change. Note that, in the next training of the model update process, training data that has never been used is used.

The true value estimation model at the time when the training end condition obtained in this manner is satisfied is the trained true value estimation model.

Note that the process of training the true value estimation model may have been executed by the control unit 11 in advance before execution of the true value estimation process, or may have been executed by another device in advance before execution of the true value estimation process. In a case where the true value estimation process is executed by another device, for example, the control unit 11 acquires a trained true value estimation model obtained by the other device before executing the true value estimation process from the other device, and executes the trained true value estimation model acquired at the time of executing the true value estimation process.

### One Example of Device That Obtains Trained True Value Estimation Model

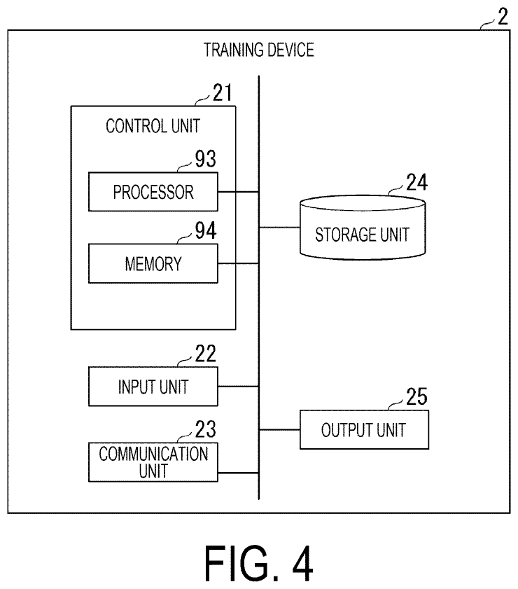

Here, an example of a device that obtains a trained true value estimation model will be described. FIG. 4 is a diagram illustrating an example of a hardware configuration of a training device 2 according to an embodiment. The training device 2 includes a control unit 21 including a processor 93 such as a CPU and a memory 94 connected via a bus and executes a program. The training device 2 functions as a device including the control unit 21, an input unit 22, a communication unit 23, a storage unit 24, and an output unit 25 by executing a program.

More specifically, the processor 93 reads out the program stored in the storage unit 24, and stores the readout program in the memory 94. The training device 2 functions as a device including the control unit 21, the input unit 22, the communication unit 23, the storage unit 24, and the output unit 25 when the processor 93 executes the program stored in the memory 94.

The control unit 21 controls operations of various functional units included in the training device 2. The control unit 21 controls, for example, operations of the output unit 25. The control unit 21 trains, for example, the true value estimation model. The control unit 21 records various types of information generated by operations of the control unit 21 in the storage unit 24.

The input unit 22 includes an input device such as a mouse, a keyboard, or a touch panel. The input unit 22 may be configured as an interface that connects these input devices to the training device 2. The input unit 22 receives inputs of various types of information to the training device 2.

The communication unit 23 includes a communication interface for connecting the training device 2 to an external device. The communication unit 23 communicates with an external device in a wired or wireless manner. The external device is, for example, a transmission destination of a trained true value estimation model. The transmission destination of the trained true value estimation model is, for example, the reception device 1. The communication unit 23 transmits the trained true value estimation model to the transmission destination of the trained true value estimation model through communication with the transmission destination of the trained true value estimation model. Note that transmitting a mathematical model means transmitting a computer program for executing a mathematical model at the time of execution. The external device is, for example, a device that is a transmission source of training data. In such a case, the communication unit 23 acquires the training data through communication with a device that is a transmission source of the training data.

Note that the training data does not have to be necessarily input via the communication unit 23, and may be input to the input unit 22. Note that a set of tentative estimated values included in the training data may be obtained by execution of tentative estimated value estimation process, for example, or may be a set of known tentative estimated values of correct answer data.

The storage unit 24 is configured using a computer-readable storage medium device (non-transitory computer-readable recording medium) such as a magnetic hard disk device or a semiconductor storage device. The storage unit 24 stores various types of information regarding the training device 2. The storage unit 24 stores, for example, information input via the input unit 22 or the communication unit 23. The storage unit 24 stores, for example, various types of information generated by execution of processing by the control unit 21. The storage unit 24 stores, for example, the true value estimation model.

The output unit 25 outputs various types of information. The output unit 25 includes, for example, a display device such as a cathode ray tube (CRT) display, a liquid crystal display, or an organic electro-luminescence (EL) display. The output unit 25 may be configured as an interface that connects these display devices to the training device 2. The output unit 25 outputs, for example, information input to the input unit 22. The output unit 25 outputs, for example, various types of information generated by training.

### Example of Flow of Processing Executed by Training Device 2

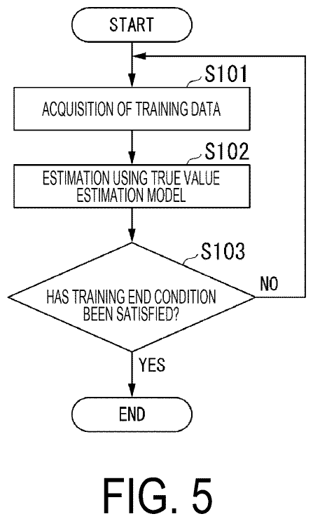

FIG. 5 is a flowchart showing an example of a flow of processing executed by the training device 2 according to an embodiment. The control unit 21 acquires training data (step S101). Next, the control unit 21 executes the true value estimation model for a set of tentative estimated values included in the training data obtained in step S101 (step S102). As a result, estimated values of the frequency offset are obtained.

Next, the control unit 21 determines whether or not the training end condition has been satisfied (step S103). If the training end condition has been satisfied (step S103: YES), the processing ends. The true value estimation model at the time when the training end condition has been satisfied is a trained true value estimation model. On the other hand, if the training end condition has not been satisfied (step S103: NO), the processing returns to step S101. In this case, the training data obtained in step S101 is unused training data that has not been used for training until then.

A first example of the true value estimation process is an example of a process of estimating the true value of the frequency offset using the trained true value estimation model obtained using supervised training. However, training is not necessarily to be supervised. That is, in a case that the true value of the frequency offset is estimated using machine learning in the subsequent estimation process, the machine learning may be supervised or unsupervised. Therefore, an example of using unsupervised training will be described as a second example of the true value estimation process.

### Second Example of True Value Estimation Process

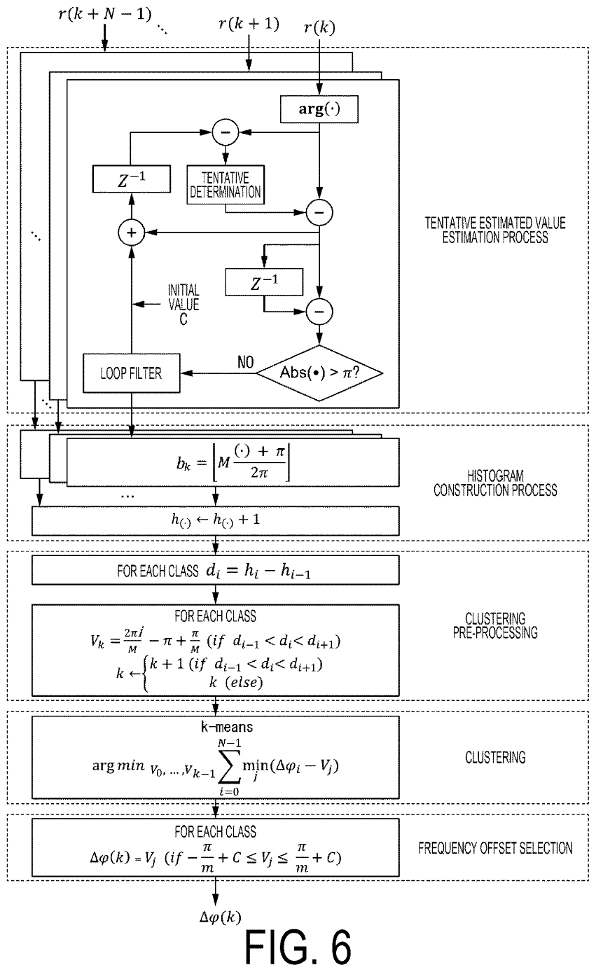

A second example of the true value estimation process will be described. FIG. 6 is an illustrative diagram for describing a second example of the true value estimation process according to an embodiment. A second example of the true value estimation process (hereinafter, referred to as a “second true value estimation process”) includes a tentative estimated value estimation process, a histogram construction process, clustering pre-processing, clustering, and a frequency offset selection process. The tentative estimated value estimation process is similar to the tentative estimated value estimation process in the first example of the true value estimation process.

The histogram construction process executes a determination process and a numerical information generation process. The determination process is a process of determining to which of M (M is an integer of 1 or greater) categories determined in advance each tentative estimated value obtained by the tentative estimated value estimation process belongs. The numerical information generation process is a process of generating information indicating the number of tentative estimated values belonging to each category based on the determination result of the determination process. In this way, the histogram construction process generates information indicating the number of tentative estimated values belonging to each category.

In the example of FIG. 6, each of h₀, . . . , and h_{M-1} indicates the number of tentative estimated values belonging to each of the categories 0, . . . , and (M−1) in this order. The information indicating the number of tentative estimated values belonging to each category is, for example, a histogram.

The clustering pre-processing is preprocessing for clustering executed at the subsequent stage. The clustering pre-processing is processing of obtaining an initial value used for clustering. Specifically, the initial value used for clustering (hereinafter, referred to as a “clustering initial value”) includes the number of clusters and the initial value of the position of each cluster.

In the clustering pre-processing, for example, the differentiation of the histogram obtained by the histogram construction process is calculated, and the number of maximum values of the histogram and the position of each maximum value are obtained. The number of obtained maximum values is the number of clusters indicated by the clustering initial value, and the position of the obtained maximum value is the initial value of the position of the cluster. Therefore, such an initial value is an initial value obtained based on the result of the histogram construction process.

Note that the position of the cluster is a position in the phase space in which a point indicates a clustering target, and means the position of the center of each cluster. Note that a clustering target is a tentative estimated value. Therefore, the phase space in which the point indicates the clustering target is a set of candidates for a tentative estimated value for which the distance is defined.

Note that, in the example of FIG. 6, each of d₀, . . . , and d_{M-1} represents the differentiation of the histogram. In the example of FIG. 6, Vₖ indicates the position of a maximum value. In the example of FIG. 6, k indicates the number of maximum values.

The clustering in the second true value estimation process is clustering in which a set of tentative estimated values obtained in the preceding estimation process is set as a clustering target, and is clustering in which an initial value obtained in the clustering pre-processing is set as an initial value. The clustering method is k-means, for example. In the clustering in the second true value estimation process, processing of changing the center of each cluster so that the distance between each tentative estimated value and the center of the cluster to which each tentative estimated value belongs is minimized is repeated until a predetermined end condition regarding clustering is satisfied.

A predetermined end condition for clustering (hereinafter, referred to as a “clustering end condition”) may be, for example, any condition as long as it is a condition related to an end of clustering. The clustering end condition is, for example, a condition that the sum of amounts of change at the centers of the clusters is smaller than a predetermined amount of change. The clustering end condition may be a condition that an amount of change at the center of a cluster is smaller than a predetermined value for any cluster, or may be a condition that the center has been changed a predetermined number of times.

The frequency offset selection process is a process of acquiring one of the centers of clusters at a time at which the clustering end condition is satisfied as a true value of the frequency offset according to a predetermined rule. The predetermined rule is, for example, a rule for acquiring, as a true value of the frequency offset, a center satisfying [C−π/m, C+π/m] among the centers of the clusters at a time at which the clustering end condition is satisfied. Note that C is an initial value of the frequency offset in the PADE. m represents a value m in a case in which a transmission optical signal is an m-PSK signal. m is an integer of 1 or greater.

The tentative estimated value estimation process in the second true value estimation process is an example of the preceding estimation process. Processing executed after the tentative estimated value estimation process in the second true value estimation process, the processing including the histogram construction process, the clustering pre-processing, the clustering, and the frequency offset selection process is an example of the subsequent estimation process.

As described above, the second true value estimation process is an example of a process of estimating the true value of the frequency offset using unsupervised training in order to estimate the true value of the frequency offset using clustering.

### <Reason for Highly-Accurate True Value of Frequency Offset Being Acquired From Second True Value Estimation Process

The reason that the highly accurate frequency offset is acquired from such a second true value estimation process is that noise is reduced by taking the central value of the tentative estimated values of a plurality of frequency offsets including noise obtained from the tentative estimated value estimation process.

More specific description will be made. First, the reason that an appropriate initial value can be obtained from the histogram construction process and the clustering pre-processing will be described. For example, in k-means, the number of clusters and the initial value of the central value of the clusters are required, and if these is no appropriate value, an appropriate value cannot be obtained as a result of clustering. Distribution and the number of clusters formed by the tentative estimated value of the frequency offset obtained in the tentative estimated value estimation process differ due to an actual frequency offset.

Therefore, the initial values of the number of clusters and the approximate center values of the clusters are obtained in advance through histogram construction and clustering pre-processing. Note that the center values of the clusters are not accurate because the frequency offset has been quantized at the time of the histogram construction. Therefore, finally, clustering is performed to obtain an accurate center value of the clusters (true value of the frequency offset). Thus, a more appropriate initial value is obtained. Note that “appropriate” means being suitable for acquiring a highly accurate frequency offset.

The reason that a highly accurate estimated value of the true value can be obtained by the clustering and the frequency offset selection process will be described.

Since the solution to the final frequency offset (that is, the true value of the frequency offset) is obtained in the range of [C−π/m, C+π/m], it is possible to obtain a highly accurate estimated value by obtaining the central value of the estimated values of the frequency offset distributed in the vicinity. Note that the reason that a value satisfying [C−π/m, C+π/m] is acquired as a true value of the frequency offset is that a highly accurate solution can be obtained in the range of [C−π/m, C+π/m] in the PADE algorithm.

### One Example of Hardware Configuration of Reception Device 1

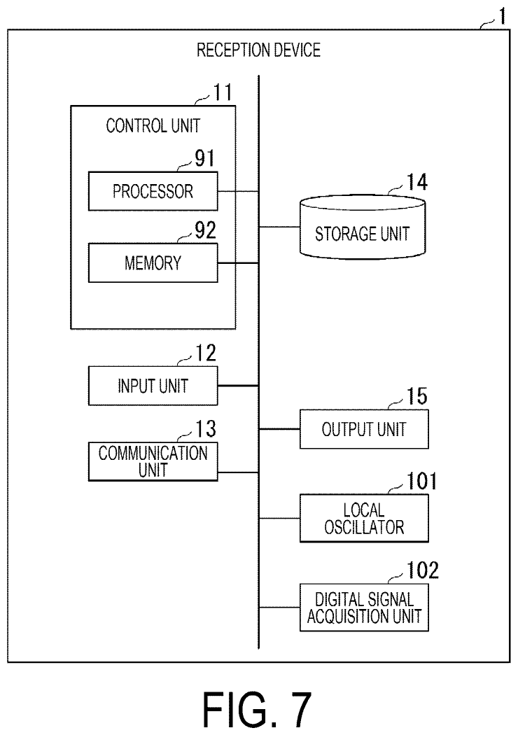

FIG. 7 is a diagram illustrating an example of a hardware configuration of the reception device 1 according to an embodiment. As described above, the reception device 1 includes the control unit 11 and executes a program. The reception device 1 functions as a device including the control unit 11, the input unit 12, the communication unit 13, the storage unit 14, the output unit 15, the local oscillator 101, and the digital signal acquisition unit 102 by executing a program.

More specifically, the processor 91 reads the program stored in the storage unit 14 and causes the memory 92 to store the read program. The processor 91 executes the program stored in the memory 92, and thereby the reception device 1 functions as a device including the control unit 11, the input unit 12, the communication unit 13, the storage unit 14, the output unit 15, the local oscillator 101, and the digital signal acquisition unit 102.

The control unit 11 controls operations of various functional units included in the reception device 1. The control unit 11 controls, for example, operations of the output unit 15. The control unit 11 controls, for example, operations of the local oscillator 101. The control unit 11 controls, for example, operations of the digital signal acquisition unit 102. The control unit 11 executes, for example, digital signal processing and a decoding process that is a process of performing decoding. The control unit 11 records various types of information generated by operation of the control unit 11 in the storage unit 14.

Note that the control unit 11 may train a true value estimation model.

The input unit 12 includes an input device such as a mouse, a keyboard, or a touch panel. The input unit 12 may be configured as an interface that connects these input devices to the reception device 1. The input unit 12 receives inputs of various types of information to the reception device 1.

The communication unit 13 is configured to include a communication interface for connecting the reception device 1 to an external device. The communication unit 13 communicates with an external device in a wired or wireless manner. The external device is, for example, the training device 2. In such a case, the communication unit 13 acquires the trained true value estimation model obtained by the training device 2 from the training device 2.

Note that, in a case that the control unit 11 trains the true value estimation model, the external device is, for example, a device of a transmission source of training data. In such a case, the communication unit 13 acquires the training data through communication with a device that is a transmission source of the training data. Note that the training data does not have to be necessarily input via the communication unit 13, and may be input to the input unit 12.

The storage unit 14 is configured by using a computer-readable storage medium device such as a magnetic hard disk device or a semiconductor storage device. The storage unit 14 stores various types of information regarding the reception device 1. The storage unit 14 stores, for example, information input via the input unit 12 or the communication unit 13. The storage unit 14 stores, for example, various types of information generated by execution of processing by the control unit 11.

The output unit 15 outputs various types of information. The output unit 15 may output, for example, the result obtained by a decoding process to a predetermined output destination. The output unit 15 includes, for example, a display device such as a cathode ray tube (CRT) display, a liquid crystal display, or an organic electro-luminescence (EL) display. The output unit 15 may be configured as an interface that connects these display devices to the reception device 1. In such a case, the output unit 15 outputs, for example, information input to the input unit 12. In such a case, the output unit 15 may output, for example, information obtained by execution of processing by the control unit 11.

### Example of Flow of Processing Executed by Reception Device 1

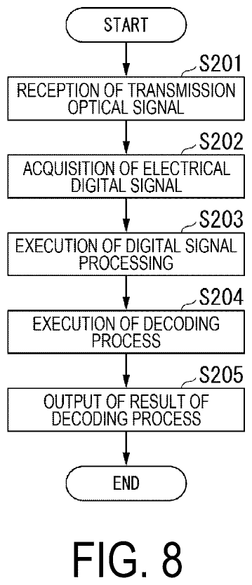

FIG. 8 is a flowchart showing an example of a flow of processing executed by the reception device 1 according to an embodiment. A transmission optical signal is incident on the digital signal acquisition unit 102 included in the reception device 1 (step S201). Next, the digital signal acquisition unit 102 acquires an electrical digital signal using the received transmission optical signal and the local oscillation light output from the local oscillator 101 (step S202). Next, the control unit 11 performs digital signal processing on the acquired electrical digital signal (step S203). In the digital signal processing, the true value estimation process is executed. In the true value estimation process, the preceding estimation process and the subsequent estimation process are executed. Next, the control unit 11 executes a decoding process (step S204). Next, the control unit 11 controls operations of the output unit 15 to output the result of the decoding process (step S205).

The reception device 1 configured as described above can estimate the true value of the frequency offset in a short time for the reason described in <Reason That the Invention Can Solve the Problem> below. Therefore, the reception device 1 can speed up the estimation of the frequency offset.

### Reason That the Invention Can Solve the Problem

The reason that the reception device 1 can estimate the true value of the frequency offset in a short time will be described. First, when a is increased, although a large noise is included in the tentative estimated value of the frequency offset, a distribution of the tentative estimated value having a single or a plurality of peaks including the vicinity of the solution and having a small half-value width is obtained with a short number of repetitions. Second, when a parameter a of a loop filter is increased, noise of a tentative estimated value of the frequency offset is increased, but a final solution can be obtained by removing noise from the tentative estimated values output from a plurality of threads through clustering or the like.

### Modification

Note that the control unit 11 included in the reception device 1 may be implemented by using a plurality of information processing devices communicatively connected via a network. In this case, each processing executed by the control unit 11 may be executed in a distributed manner by a plurality of information processing devices.

Note that the control unit 21 included in the training device 2 may be implemented by using a plurality of information processing devices communicatively connected via a network. In this case, each processing executed by the control unit 21 may be executed in a distributed manner by a plurality of information processing devices.

Note that all or some of the functions of the reception device 1 and the training device 2 may be implemented by using hardware such as an application specific integrated circuit (ASIC), a programmable logic device (PLD), or a field programmable gate array (FPGA). The program may be recorded in a computer-readable recording medium. The computer-readable recording medium is, for example, a portable medium such as a flexible disk, a magneto-optical disk, a ROM, or a CD-ROM or a storage device such as a hard disk built in a computer system. The program may be transmitted via an electrical communication line.

Note that the reception device 1 is an example of a communication device.

Although the embodiments of the present invention have been described in detail with reference to the drawings, specific configurations are not limited to the embodiments, and include design and the like within the scope of the present invention without departing from the gist of the present invention.

### REFERENCE SIGNS LIST

100 Communication system
1 Reception device
11 Control unit
12 Input unit
13 Communication unit
14 Storage unit
15 Output unit
101 Local oscillator
102 Digital signal acquisition unit
2 Training device
21 Control unit
22 Input unit
23 Communication unit
24 Storage unit
25 Output unit
9 Transmission device
901 Light source
902 Intensity modulator
91 Processor
92 Memory
93 Processor
94 Memory

1. A communication device comprising:
a processor;
a storage medium having computer program instructions stored thereon, wherein the computer program instruction, when executed by the processor, perform processing of:
performing a true value estimation process of estimating a true value of a frequency offset based on an electrical digital signal that is a digital signal obtained based on an optical signal that is an optical signal received in a digital coherent reception method and indicating a symbol string composed of a plurality of symbols and a local oscillation light and a digital signal transmitting the symbol string with an electrical signal,
wherein, in the true value estimation process,
a preceding estimation process of estimating a tentative estimated value that is a value of the frequency offset for each of the symbols included in the electrical digital signal, and
a subsequent estimation process of estimating the true value based on a set of the tentative estimated values estimated in the preceding estimation process are executed.

2. The communication device according to claim 1, wherein the tentative estimated value of each of the symbols estimated in the preceding estimation process is obtained by executing a PADE on each of the symbols.

3. The communication device according to claim 1,
wherein the subsequent estimation process estimates the true value by using a trained mathematical model obtained from supervised machine learning that is a mathematical model for estimating the true value based on the set of the tentative estimated values obtained from the preceding estimation process.

4. The communication device according to claim 3,
wherein the trained mathematical model is obtained through training in which a pair of the set of the tentative estimated values obtained from the preceding estimation process and correct answer data is used as training data and the correct answer data indicates the true value.

5. The communication device according to claim 1,
wherein, in the subsequent estimation process, the true value is estimated from unsupervised machine learning.

6. The communication device according to claim 5,
wherein the unsupervised machine learning is clustering for the set of the tentative estimated values obtained from the preceding estimation process.

7. A frequency offset estimation method comprising:
performing a true value estimation process of estimating a true value of a frequency offset based on an electrical digital signal that is a digital signal obtained based on an optical signal that is an optical signal received in a digital coherent reception method and indicating a symbol string composed of a plurality of symbols and a local oscillation light and a digital signal transmitting the symbol string with an electrical signal,
wherein, in the true value estimation process, a preceding estimation process of estimating a tentative estimated value that is a value of the frequency offset for each of the symbols included in the electrical digital signal, and
a subsequent estimation process of estimating the true value based on a set of the tentative estimated values estimated in the preceding estimation process are executed.

8. A non-transitory computer readable medium which stores a program for causing a computer to function as the communication device according to claim 1.
